(19) United States
(12) Patent Application Publication
(10) Pub. No.: US 2009/0148819 A1
(43) Pub. Date: Jun. 11, 2009

(54) Motivate and award system with escrow accounts to reserve and store specific selected or requested awards

(76) Inventor: Yii-Shyun Lin, Los Altos Hills, CA (US)

Correspondence Address: BO-IN LIN, 13445 MANDOLI DRIVE, LOS ALTOS HILLS, CA, 94022, US

(21) Appl. No.: 12/315,793

(22) Filed: Dec. 5, 2008

Related U.S. Application Data
(60) Provisional application No. 61/005,633, filed on Dec. 5, 2007.

(51) Int. Cl. G09B 19/00

(52) U.S. Cl. 434/236

(57) ABSTRACT

A system and method to award a person to engage and complete a designated activity by setting up an escrow account with monetary funds or award items ready to reward the person immediately following the completion of the activity. The timeliness of the award can enhance the effectiveness of the motivation system.

This Non-provisional Application claims a Priority Date of Dec. 5, 2007 benefited from a Provisional Patent Applications 61/005,633 filed by an Applicant as one of the Inventors of this Application. The disclosures made in Patent Application 61/005,633 are hereby incorporated by reference in this Application.

### BACKGROUND OF THE INVENTION

1. Field of the Invention

This invention relates generally to systems, methods, and processes to motivate targeted activities or tasks by providing a motivating award system. More particularly, this invention is related to a system and process for setting up reservation and escrow accounts with systems and methods to monitor and provide awards to motivate specific targeted activities or tasks.

2. Description of the Prior Art

Current methods and processes for rewarding a person for engaging or completing beneficial or desirable activities and tasks often occurs after the person has already completed the activity. These methods and systems usually do not provide sufficient motivation or incentives due to the fact that the award is too remote and uncertain from the perspective of the designated award receiver. The rewarding or awarding processes are also often arranged without the participation or selection of the person designated to receive the award. The methods and processes often lack sufficient motivation because awards are often determined and designated entirely by the parties that provide the award. For these reasons, the effectiveness of motivation is reduced.

Additionally, many people would like to motivate a designated person or group of people to engage in beneficial or desirable activities or complete targeted tasks, but there are no efficient and relevant systems for providing such motivations. Such situations are particularly common when the “motivators”, for example parents or grandparents, plan to motivate their children or grandchildren to complete certain tasks. Due to a potential generation gap and/or different perspectives on life between the “motivator” and the “motivatee” the motivators may not understand or know how to best motivate the motivatee to complete the specific designated tasks or activities. Additionally, tracking the completion of the behavior may put a strain on the relationship. Also, under most circumstances, when personal awards are offered to encourage the designated person to perform targeted tasks or to engage in specific activities, the award is controlled entirely by the award provider, and the award is offered only as a promise. The designated award receiver generally does not have a more definite and assured motivation to complete the activities or tasks the award provider wishes to motivate. The effectiveness of motivation is also reduced because there are uncertainties about whether the promise offered by the award provider can be eventually realized.

Therefore, there is still a need to provide new and more effective method and system such that the above discussed difficulties and limitations may be overcome.

### SUMMARY OF THE PRESENT INVENTION

It is therefore an aspect of the present invention to provide a new and improved a motivate-and-award system and process by setting up an escrow account with an award deposited into the escrow account ready to award a designated person to perform a designated activity or perform designated tasks such that a stronger incentive is established to motivate the completion of such activity or the performance of tasks.

It is another aspect of this invention to provide a new system and process to streamline and expedite the motivate-and-award process with biometric scanners for scanning a biometric characteristic of the designated person once the motivated activity is completed. The motivate-and-award system is simplified and expedited to provide greater incentive for motivating the designated person to complete the designate activities.

It is another aspect of this invention to provide a new system and process to increase an award according to a designated scale based on a measurable aspect (i.e. frequency, length of time engaged in activity, etc.) of the designated person completing the designated activity in order to provide an increased incentive to motivate the designated person to consistently complete the designated activity with an increase in the desired measurable aspect of the activity (i.e. frequency, length of time engaged in activity, etc.).

It is another aspect of this invention to provide a new system and process to increase an award according to a designated scale based on a measurable aspect of a beneficial result to the designated person due to the completion of the designated activity, in order to provide an increased incentive to motivate the designated person to consistently complete the designated activity. For example, a person who is encouraged to complete a blood sugar level reduction program is given a greater award, with the award deposited in an escrow account by an award provider intending to encourage the designated person to complete the blood sugar level reduction program, when there is a greater blood sugar level reduction.

In an exemplary embodiment, the system and process may increase an award proportionally according to a weight reduction of a person exercising in a fitness center equipped with scanner and scale to scan the number of times a person exercises in the fitness center over a given period of time and the weight reduction respectively resulting from fitness programs completed by the designated individual.

Specifically, it is an aspect of the present invention to provide a system and method to award a person to engage in and complete a designated activity by setting up an escrow account with monetary funds or award items ready to award the person immediately following the completion of the activity. The timeliness of the award can enhance the effectiveness of the motivation system.

This invention discloses a method for awarding a designated person to complete a designated activity. The method includes a step of depositing an award in an escrow account ready to award the designated person immediately after the designated person completes the designated activity. In an exemplary embodiment, the method further includes a step of scanning a biometric characteristic of the designated person after the designated person completes the designated activity.

These and other objects and advantages of the present invention will no doubt become obvious to those of ordinary skill in the art after reading the following detailed description of the preferred embodiment, which is illustrated in the various drawings and figures.

### BRIEF DESCRIPTION OF THE DRAWINGS

FIG. 1 is a functional block diagram showing a motivate-and-award system of this invention.

FIG. 2 shows an exemplary embodiment in which an employer, functioning as the award provider, deposits an award to the award escrow account of FIG. 1 under an employee fitness award program.

FIG. 3 is a functional block diagram to show a motivate-and-award system with an award reservation and escrow account of this invention to allow an individual to select and reserve an award.

FIG. 4 is a functional block diagram to show a motivate-and-award system with an award select, request, and reservation processor and escrow accounts of this invention.

FIG. 5 is a flowchart for showing the processes of providing awards to motivate a designated award receiver to complete specific tasks or to engage in designated activities designated by an award provider.

### DETAILED DESCRIPTION OF THE PREFERRED EMBODIMENT

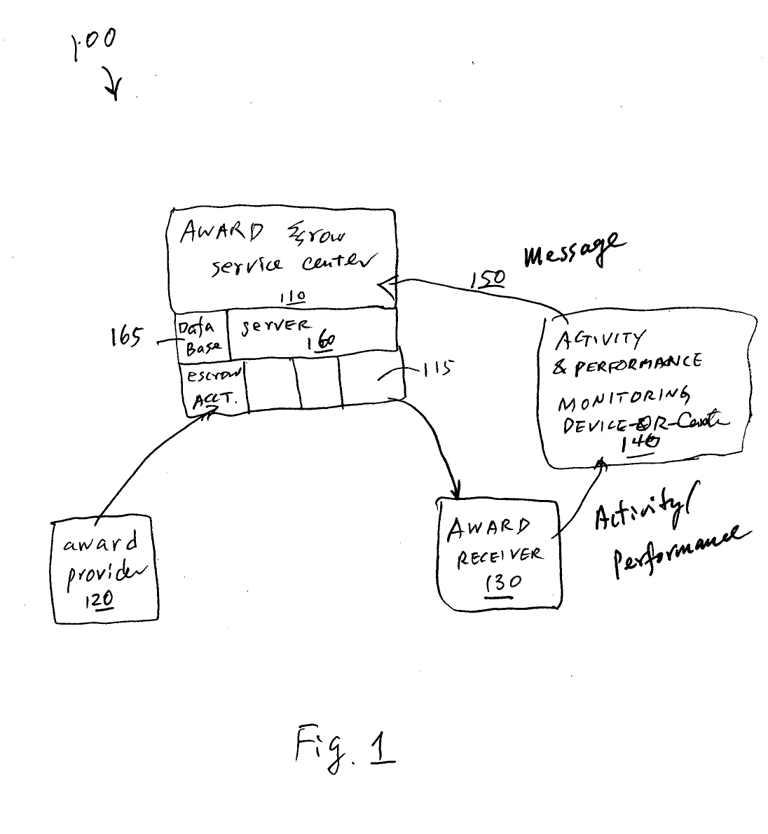

FIG. 1 is a functional block diagram showing a motivate-and-award system 100. The motivate-and-award system 100 includes an award escrow service center 110. The award escrow service center 110 has a plurality of escrow accounts 115 to receive and store awards received from an award provider 120. The awards may be monetary payments, gift certificate or awards in other forms such as hotel coupons, stocks, bonds, video games, or different kinds of awards targeted to motivate different kinds of award receivers. Each of the award providers 120 designates at least one award receiver 130 to receive the awards stored in the award escrow accounts 115. The award provider 120 further provides conditions to motivate the award receiver 130 to complete certain activities, perform certain tasks, or to satisfy certain standards in order to receive the award. The motivate-and-award system 100 further includes an activity performance and monitoring device-or-center 140 to monitor the activity and performance of the award receiver 130. The activity performance and monitoring device-or-center 140 sends a message 150 to the award escrow service center 110 to notify the award escrow service center that the award receiver 130 has completed the required activity, performed the required task, or satisfied the required condition. When the award escrow service center 110 receives the message 150, the award escrow service center 150 notifies the award provider 120 to obtain an authorization to transfer the award to the award receiver 130. The award escrow service center may also be implemented with a computer server 160 that has a database 165 to store and keep track of the escrow accounts 115 and the activities of the award receiver 130 in the process of fulfilling the conditions in order to receive the award. In an exemplary embodiment, this server 160 may be connected through the Internet or other network systems to communicate and transfer messages and award funds or other network transferable items in monitoring and awarding the motivatee as an award receiver 130.

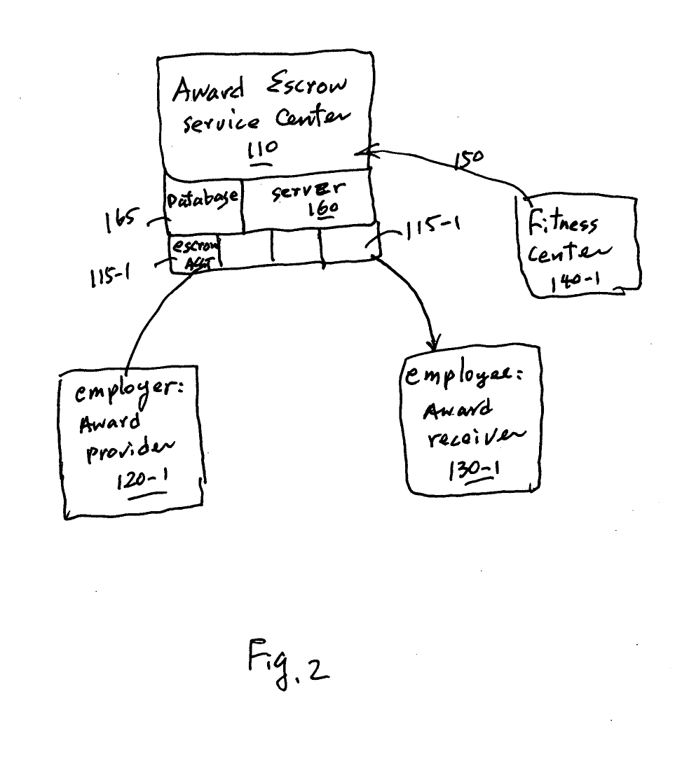

FIG. 2 shows an exemplary embodiment wherein the award provider, an employer 120-1, deposits an award into the award escrow account 115-1 under an employee fitness award program to award the employees 130-1. When an employee 130-1 completes a certain number of fitness activities in a fitness center 140-1, the fitness center 140-1 notifies the award escrow service center 110, and the award escrow service center 110 notifies the employer 120-1. The employer 120-1 authorizes the award escrow service center 110 to transfer the award stored in the award escrow account 115 to the employee 130-1 as the award receiver.

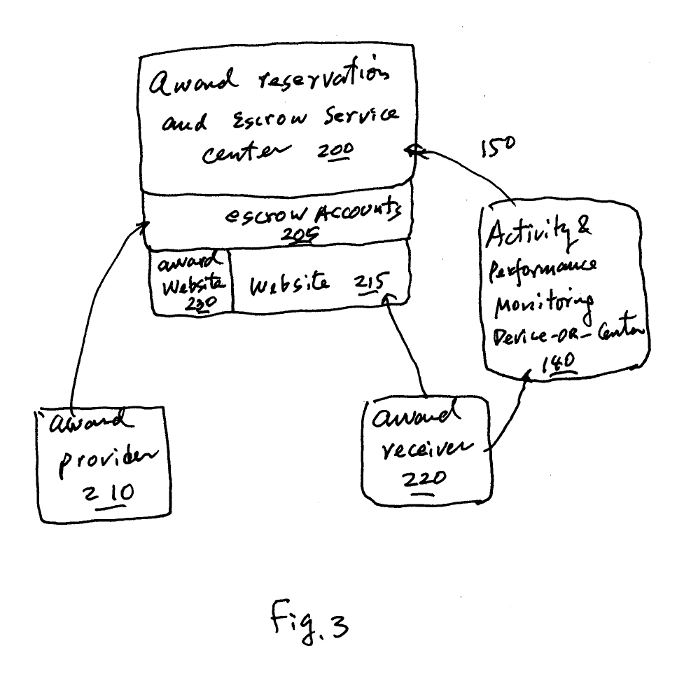

FIG. 3 shows an award reservation and escrow service center 200 that includes many escrow accounts 205 for receiving deposits as down payments from an award provider 210. In an exemplary embodiment, the award reservation and escrow center 200 sets up a Website 215 for a person 220 assigned by the award provider 210 as a “motivatee” to receive the award by fulfilling certain conditions that most likely include activities or tasks the award provider would like to motivate the award receiver to perform and complete. The award receiver 220, as a motivatee, may log onto a Website 215 of the reservation and escrow center to link to an award website 230. The motivatee can then select and reserve an award. The motivatee may select and reserve specific awards provided by the motivator. The purpose of allowing the motivatee to select and reserve specific awards is to provide definite, specific, and strong motivation for the motivatee to fulfill the conditions in order to receive the award. Examples of the selected and reserved awards may include airline tickets and hotel coupons on selected dates on an airline to specific vacation locations. The selected and reserved awards are then deposited into the database of the reservation and escrow account 200 guaranteed by the deposit as a down payment of the reserved awards. The motivatee is then motivated to complete the motivated activities, such as completing a certain number of fitness programs, losing body weight of certain number of pounds, or graduating from the high school while completing a certain number of advance placement (AP) courses, etc. Once the motivated activity or the performance of certain tasks is completed, the selected and reserved awards stored in the reservation and escrow account are transferred to the account of the motivatee, which is set up as a separate account in the award reservation and escrow center 200.

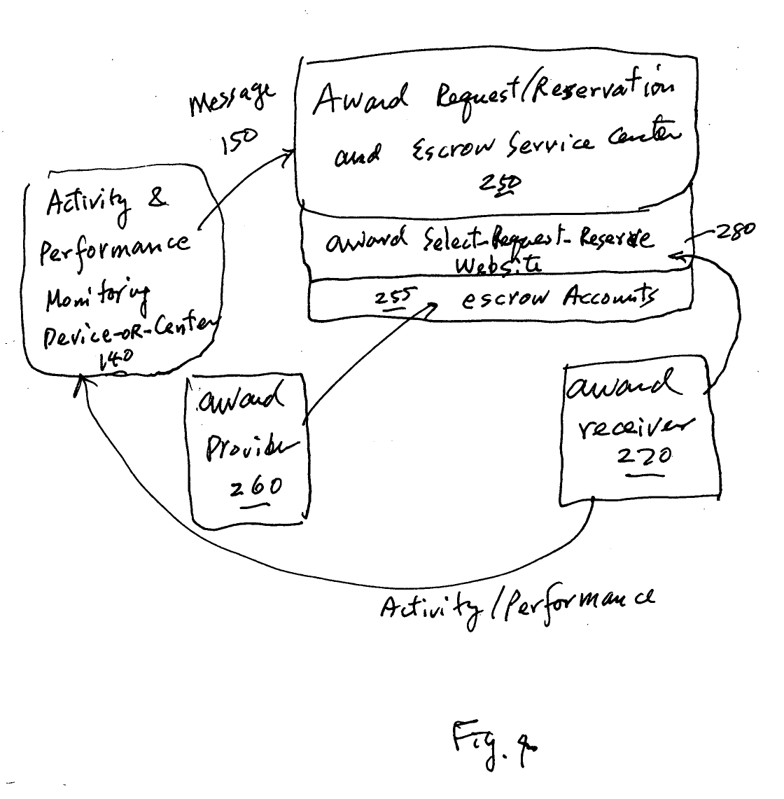

FIG. 4 shows an award request/reservation and escrow service center 250 that includes many escrow accounts 255 for receiving a deposit as a down payment from an award provider 260 as a motivator. In an exemplary embodiment, the award reservation and escrow center sets up a Website for a person 270 as a “motivatee” assigned by the award provider 260, the motivator, to link to an award select-request-reserve website 280. The designated award receiver 270, as a motivatee, can select and reserve an award if the selectable awards listed in the select-request-reserve website 280 includes an award item that would satisfy the designated award receiver 270. Or, the designated award receiver 270 can request an award for approval by the award provider 260. Once the requested award is approved by the award provider 260, the designated award receiver 270 can link to the select-request-reserve website 280 again to select and reserve the request award for deposit into the award escrow account 255. On the other hand, if the award provider does not approve the requested award, additional selectable awards can be added based on the requested award submitted by the designated award receiver for the award receiver to either select from or to again request a different award. The request is then submitted again to the award provider 260 for approval. The process can be reiterated until the award provider 260 approves an award requested by the designated award receiver 270. This process and system allows a better motivation for the designated award receiver 260 to request an award according to his or her own wish list rather than an award totally dictated by the award provider 260.

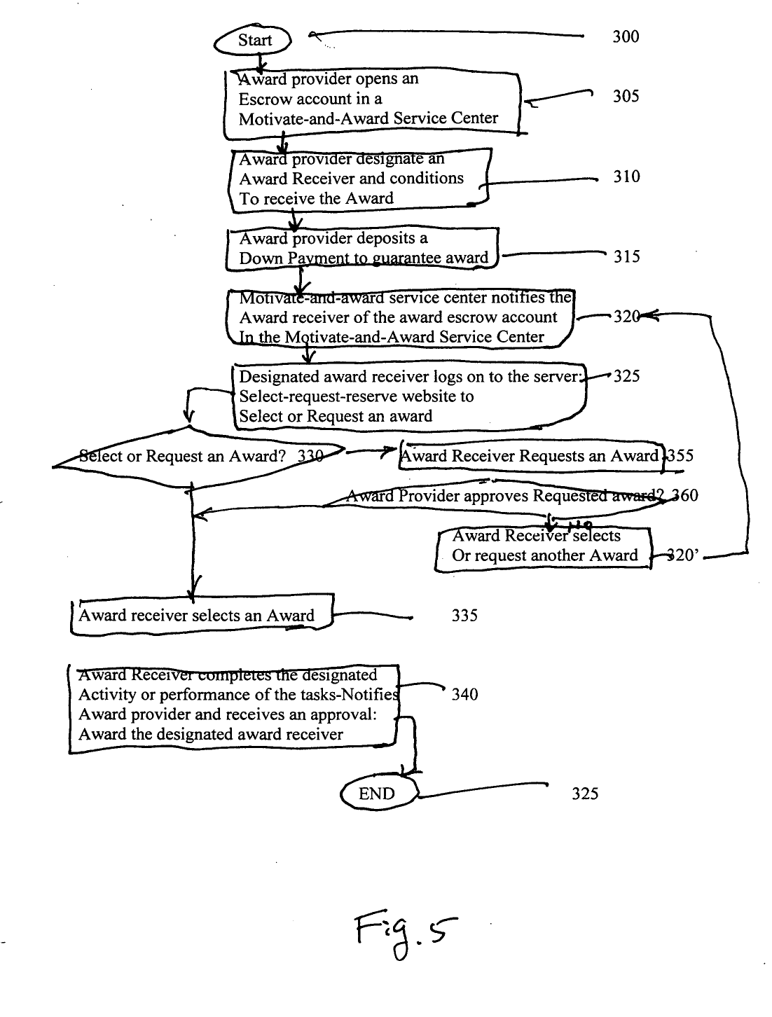

FIG. 5 is a flowchart for illustrating the processes for an award provider 260, as a motivator, to motivate a designated award receiver, as a motivatee, to engage in and complete specific activities or to perform certain designated tasks. The processes start (step 300) when an award provider opens an award account with a motivate-and-award service center (step 305). Then, the award provider designates a person to receive the award and the conditions under which the award receiver will receive the award (step 310). The award provider further deposits a down payment to the escrow account as a guarantee of the award (step 315). This step may be optional depending on the processing requirements of the motivate-and-award service center. The motivate-and-award service center then notifies the award receiver of the award escrow account (step 320). The award provider may also notify the award receiver of the availability of this award escrow account to better motivate the motivatee. In some circumstances, the award provider may want to act as an anonymous motivator without disclosing his or her own identity. The designated award receiver then logs on to the server of the motivate-and-award center and links to a select-request-reserve website to select or request an award (step 325). The process proceeds with a step of determining whether the award receiver has selected an award or has made an award request (step 330).

If the designated award receiver has selected an award item already included in the award list provided by the award provider, the process proceeds with a step of monitoring the activity or performance of the designated award receiver (step 335) and is followed by determining the completion of the designated activity or performance of the tasks. The motivate-and-award service center also notifies the award provider the status of the completion and receives an approval from the award provider to award the designated award receiver (step 340) before the end of the motivate-and-award process (step 350).

On the other hand, if the designated award receiver has requested an award item not yet included in the award list provided by the award provider, the process proceeds with a step of sending the request to the award provider to receive an approval from the award provider (step 355). A determination is made to find out whether the award provider approves the request submitted by the designated award receiver (step 360), and if the award provider approves the request, the process proceeds with steps 335 to 350 as described above. If it is determined that the award provider does not approve the requested award item submitted by the designated award receiver, the motivate-and-award service center notifies the designated award receiver again (step 320′), and reiterate the steps as that follow the processing step 320 until the end of the motivate-and-award process (step 350).

It is understood that the award provider may be an individual, institution, or multiple parties that include individuals with institutions of commercial entities. Furthermore, the down payment made to the escrow account may be in different forms such as in monetary funds, company stocks, airline tickets, or even physical objects such as a video game or software CD or anything of value that can motivate the motivatee. Similarly, the motivated escrow accounts may store awards provided by the award provider in different forms and shapes that may most effectively motivate the motivatee to fulfill the conditions for receiving the award. Optionally, an anticipated award ticket or certificate may be sent to the designated award receiver to remind the designated award receiver that an award is stored and reserved in the award escrow account to encourage and motivate the motivatee to complete the tasks or activities in order to receive the award specified in the award ticket or certificate.

In an alternate embodiment, the award provider, as a motivator, may want to encourage certain types of activities that are beneficial to the entire society, such as picking up litter from the streets in a particular city. A bid for an award may be posted on an Internet Website to allow many potential award receivers to bid for the award by presenting the number of pounds of litter collected during a set time period. The award stored in an escrow account may then be awarded to the highest bidder who has collected the largest amount of litter. A city government joined with another institution as award providers may provide further incentives to add more awards when the goals are achieved, e.g., when the amount of litter collected from the streets in a city exceed a certain predefined thresholds.

This invention therefore discloses a method for motivating and awarding an achievement of a target goal. The method includes a step of opening an escrow account for depositing an award and receiving bids from a plurality of motivatees related to the achievement of the target goal for selecting and awarding an award receiver among the plurality of motivatees. For example, diabetic society may join forces with a fitness center or other public health institution to encourage exercise programs that reduce blood sugar levels from a plurality of diabetic patients. An award may be deposited into an escrow center to receive bids from among many patients and to be awarded to selected patients who have achieved the greatest reduction of blood sugar level or other indicators that would be most beneficial to the health of the diabetic patients.

This invention discloses a method for motivating a person as a motivatee to perform a task or complete an activity in order to achieve a target goal. The method includes a step of establishing and depositing an award guarantee into an award escrow account to motivate the motivatee to achieve the targeted goal.

This invention discloses a motivate-and-award system for motivating a person as a motivatee to perform a task or complete an activity in order to achieve a target goal. The system includes a motivate-and-award service center providing an award escrow account for depositing an award guarantee into the award escrow account in the motivate-and-award service center to motivate the motivatee to achieve the targeted goal.

This invention discloses a motivate-and-award system for motivating a person as a motivatee to perform a task or complete an activity in order to achieve a target goal. The system includes a motivate-and-award service center providing an award select-reserve system for the motivatee to select from a list of awards for depositing into an escrow account. Furthermore, the award select-reserve system enables the motivatee to reserve a specific selected award and to store the award in the escrow account.

This invention discloses a motivate-and-award system for motivating a person as a motivatee to perform a task or complete an activity in order to achieve a target goal. The system includes a motivate and award service center providing an award select-request-reserve system for the motivatee to either select from a list of awards or request an award not included in the list of awards for depositing into an escrow account. Furthermore, the award select-request-reserve system enables the motivatee to reserve the award and to store the award in the escrow account.

Although the present invention has been described in terms of the presently preferred embodiment, it is to be understood that such disclosure is not to be interpreted as limiting. Various alternatives and modifications will no doubt become apparent to those skilled in the art after reading the above disclosure. Accordingly, it is intended that the appended claims be interpreted as covering all alterations and modifications as fall within the true spirit and scope of the invention.

We claim:

1. A method for awarding a designated person to complete an intended activity comprising:
storing an award in an escrow account and monitoring the designated person completing said intended activity for awarding said designated person for completing said intended activity.

2. The method of claim 1 further comprising:
informing said designated person step of storing said reward in said escrow account further includes a step of setting said escrow account for directly transferring said reward to said designated person upon receiving a predefined signal relating to said designated person completing said intended activity.

2. The method of claim 1 wherein:
said step of storing said reward in said escrow account further includes a step of setting said escrow account for directly transferring said reward to said designated person upon receiving a predefined signal relating to said designated person completing said intended activity.

3. The method of claim 1 wherein:
said step of storing said reward in said escrow account further includes a step of storing an electronic airline ticket in said escrow account for directly transferring said electronic airline ticket to said designated person upon receiving a predefined signal relating to said designated person completing said intended activity.

4. A system of for rewarding a designated person to complete an intended activity comprising:
a reward escrow service center for storing a reward in an escrow account and for keeping a record of said intended activity completed by said designated person for issuing an incentive reward to said designated person based on said record of said intended activity completed by said designated individual.

5. The system for rewarding said designated person to complete said intended activity of claim 1 wherein:
said reward escrow service center further sending a reminder to said designated person for reminding said designated person of said incentive rearward for completing said intended activity.

6. The system for rewarding said designated person to complete said intended activity of claim 1 further comprising:
a reward provider for setting up and depositing said reward into said escrow account with said reward escrow service center.

7. The system for rewarding said designated person to complete said intended activity of claim 1 wherein:
said reward escrow service center further keeping a record of a health-enhancement activity completed by said designated person for issuing an incentive reward to said designated person based on said record of said health-enhancement activity completed by said designated individual.

8. The system for rewarding said designated person to complete said intended activity of claim 1 wherein:
said reward escrow service center further keeping a record of an intelligence-enhancement activity completed by said designated person for issuing an incentive reward to said designated person based on said record of said intelligence-enhancement activity completed by said designated individual.

9. The system for rewarding said designated person to complete said intended activity of claim 1 further comprising:
an employer as a reward provider for setting up and depositing said reward into said escrow account with said reward escrow service center for an employee as said designated person for rewarding said employee to complete an employer intended activity.

10. The system for rewarding said designated person to complete said intended activity of claim 1 further comprising:
an insurance company as a reward provider for setting up and depositing said reward into said escrow account with said reward escrow service center for an insured as said designated person for rewarding said insured to complete an insurance company intended activity.

11. The system for rewarding said designated person to complete said intended activity of claim 1 wherein:
said reward escrow service center further storing a monetary reward in said escrow account for issuing a monetary incentive reward to said designated individual.
